(19) United States
(12) Patent Application Publication
(10) Pub. No.: US 2009/0254474 A1
(43) Pub. Date: Oct. 8, 2009

(54) System and Method for Liquefying and Extracting Liquidity fromn Illiquid Assets without Debt or Divestiture.

(76) Inventor: Garry D. Gladstone, Incline Village, NV (US)

Correspondence Address: PETER A. HAAS, ESQUIRE, 1929 SW 13TH AVENUE, PORTLAND, OR, 97201, US

(21) Appl. No.: 12/352,836

(22) Filed: Jan. 13, 2009

Related U.S. Application Data
(60) Provisional application No. 61/042,031, filed on Apr. 3, 2008.
(60) Provisional application No. 61/090,949, filed on Aug. 22, 2008.

(51) Int. Cl. G06Q 40/00; G06Q 90/00

(52) U.S. Cl. 705/37; 705/500

(57) ABSTRACT

One embodiment of the present invention includes a system and method of liquefying an illiquid asset for the purpose of extracting liquidity. The asset owner retains ownership, control, possession, and use of the asset for the duration of a contractual period. The extracted liquidity is a portion of the value of the asset and is provided to the asset owner from an asset buyer as an earnest money purchase deposit. During the contract period the asset owner may avoid the completion of the sale of the asset to the asset buyer by various means. According to the present invention, an asset owner incurs no debt burdens, yet obtains liquidity and maintains control of the asset.

### PRIORITY CLAIM

This present application claims benefit under 35 U.S.C. Section 119(e) of U.S. Provisional Patent Application Ser. No. 61/090,949, filed on 22 Aug. 2008 and U.S. Provisional Patent Application Ser. No. 61/042,031 filed on 3 Apr. 2008, the disclosures of which are expressly incorporated by reference for all purposes.

### BACKGROUND

The present invention relates to business models, methods, and tools that enable an owner of a non-liquid (illiquid) asset to liquefy and extract capital from the asset temporarily without relinquishing ownership or possession of the asset. Specifically, the present invention relates to a business model and method for extracting capital (liquidity) from an asset without the asset owner incurring new debt obligations, and with the asset owner retaining possession, control and use of the asset, for at least a defined period of time.

The prior-art includes financial models, methods, and tools for converting an illiquid asset owned by the asset owner into liquid assets. Traditional methods include a sale of the asset by the asset owner to a buyer (asset buyer). This simple transfer of all title, rights and interest in the asset from the asset owner to the asset buyer pre-dates our written history. However, this transfer deprives the asset owner from future use or interest in the asset, and therefore, may not fully suit the financial needs of the asset owner.

A well-known and common solution for an asset owner is to use the asset as collateral for a loan. In this scenario, a lender obtains a security interest in the asset as collateral, and the asset is used to secure the obligation to ensure the asset owner makes all payments as agreed and eventually repays the loan in full. Unfortunately, the need for liquidity may come at a time when the asset owner may not have the necessary risk tolerance and/or financial capacity to take on the burden of any new debt obligation. Therefore, this method is very often not a viable or even advisable option.

Another common, prior-art model teaches a lease or rental of the asset by the asset owner to a lessee. While the asset owner retains a future interest in the asset, during the lease term the asset owner relinquishes possession of the asset. Again, this prior-art model does not fully suit the financial needs of an asset owner who desires both liquidity and current possession of the asset.

A contract for an option for the future sale of an asset—as in a typical real estate transaction—enables the asset owner to retain current possession, title, and use of the asset, but typically does not provide for the use of significant amounts of current new capital (liquidity) from the asset, if any. Even if the use of substantial liquidity was somehow actually provided using this method, the effect would not be temporary. Rather, upon the asset buyer/option holder's exercise of the option at anytime during the option period, the asset seller/option grantor is required to specifically perform by selling the asset upon demand. Again, this prior-art model does not fully suit the liquidity needs of every asset owner, particularly the asset owner that desires liquidity and possession of the asset now, and also the right to maintain ownership of the asset in the future.

More recent financial models in the prior art include U.S. Pat. No. 5,083,270 to Gross et al. issued on 21 Jan. 1992 entitled “The Method and Apparatus for Releasing Value of An Asset.” This reference teaches a method of extracting liquidity from real property assets without the immediate sale or loss of possession. While this provides current use of the asset and provides current liquidity, it creates a new financial obligation or debt to the asset owner in the form of a promissory note and secured by a mortgage on real property, with the absolute duty of repayment in full upon the demise of the owner. The disclosed method relies on a premise that—upon the owner's demise—the proceeds of the liquidation of the real property will be sufficient to repay the loan principal and any accrued interest. However, if that were not the case, then any deficiency balance would still be required to be paid out of other assets of the estate or heirs. These are obligations of debt, which, by definition, include the absolute duty to repay, and the associated inherent characteristic of keeping all of the risk of adverse change in the asset value on the shoulders of the asset owner. Thus, there remains a need for a financial model that avoids this debt-burden, yet still enables the asset owner to retain current possession of the asset and gain liquidity from it, and one which is not limited exclusively to owners of real property assets.

Another financial model of the prior art, U.S. Pat. No. 6,615,187 to Ashenmil et al. issued on 2 Sep. 2003 entitled “Method of Securitizing and Trading Real Estate Brokerage Commissions,” teaches a method of monetizing the right to a real estate brokerage commission for successful representation on a future transaction. The methods of this reference only apply to future speculative prospective rights in the intangible asset of a right to attempt to provide services. Further, its primary aim is to provide liquidity to the real estate broker by means of an immediate sale of the broker's newly created intangible asset. Even to the extent that it may be loosely related to the underlying tangible asset of the real estate owner, by making the assumption that the real estate owner would not grant this future right without some monetary remuneration, since a real estate commission is generally never more than 10% of the value of a property, and since a real estate broker would have no practical incentive to advance an amount anywhere near the full amount of the prospective commission to the property seller merely for the right to attempt to earn it all back at some uncertain date in the future, the amount of liquidity that could be garnered by a real estate owner using this prior art would only amount to a miniscule percentage of the value of the real property asset. Further, any such unintended use, aside from the issue that it was apparently not contemplated or actually taught, would be limited solely to owners of real estate assets. Most importantly, this prior art only teaches the creation of liquidity for one specific intangible and uncommon asset in the form of a real estate broker's option to provide future real estate brokerage services to a real estate owner.

Yet another prior-art financial model includes U.S. Pat. No. 5,694,552 issued to Aharoni on 2 Dec. 1997 entitled “Financing Method Incorporating New Use of Trade Acceptance Drafts.” This reference teaches a new use of an old instrument using a complex 3-party arrangement specifically used to repay an existing commercial debt.

A reverse-equity mortgage, for example as described in U.S. Pat. No. 6,012,047 issued to Marzonas et al. on 4 Jan. 2000, provides current liquidity in the form of a periodic future payment based on the present value of a real estate property and its future worth. However, this model acts as a loan, which must be repaid and should the actual realized future worth of the asset be less than the predicted value, then third party insurance guarantees (typically from the Federal Housing Administration) paid for by the borrower, are used to assure that the lender is repaid in full. Moreover, due to the long-term risks and the costs of the guarantees, the total percentage of the asset value that can be realized is typically small for people under 65 years of age and the amount available may not fully address certain asset holder's needs for immediate liquidity. Further, its use is limited to owners of residential real estate assets who are at least 62 years old.

Yet another financial model of the prior art includes a “System and Method for Depositing and Investing Illiquid or Restricted Assets” as described in U.S. Patent Application Number US 2004/0054613 published on 18 Mar. 2004 and submitted by Dokken. In this reference, an illiquid asset is deposited into an investment fund, which consists of a pooling of illiquid assets deposited by many owners of such assets. Once so pooled, the combined asset value is used to secure margin loans for the purchase of other investment securities, for the purpose of gaining a return. This tool, however, is clearly focused on serving owners of intangible assets such as illiquid and/or restricted investment securities who are seeking to diversify their investments, it also requires divestment of the asset in the eventuality that the investments lose value, and it typically requires the asset owner to relinquish possession of the asset during the contract period.

Yet another financial model of the prior art includes a product commercially known as a “REX agreement” available at www.rexagreement.com as promulgated by Rex and Company located at 101 California Street, suite 1950 in San Francisco, Calif., USA. This model utilizes a shared asset value appreciation over time and is limited to real property. This model does not use personal property, which is well-known (with few exceptions) to decline in value over time. This model is further limited to real property in the form of well-located owner-occupied, single-family detached homes in good condition. Further the real property must not be in either the top or bottom 10% of the home values in their area. Further this model requires that the real property be owned by individuals with good credit and who can accept receiving an amount of funds that averages only 10 to 15% of the value of the asset. A further limitation of this REX Agreement (RA) model is that the practitioners are not asset buyers or asset dealers of any kind. Therefore, the RA does not provide the aspect of acting as a back up buyer standing ready to provide the asset owner with the full 100% liquidity any time upon demand. Rather, in reality RA is really just an unregistered futures contract wherein the money given to the homeowner is actually a margin deposit used to induce the homeowner to enter into a long-term cash-settled futures contract which allows the practitioner to gain or lose money by speculating on portion the future change in value of a house. And, because the RA contract is based on speculation rather than actual commerce, the RA practitioner has no alternate sources of related revenues to anticipate. Therefore, it is more limited in that it must be practiced in a fashion that requires a fee for cancellation. Additionally, the RA requirement of owner occupancy does not provide full control over the real property asset to the asset owner. Rather, the owner is specifically constrained from moving out and renting his house to others. Finally, because the RA does not include the use of an asset dealer, selling agent or guaranteed purchase contract, and it uses a long contract period of 50 years (or 30 years where 50 is not permitted), the RA does not contemplate or provide any practical means for the practitioner to benefit from the pre-marketing of anticipated near-term potential “virtual” inventory.

Thus, there remains a need for a system and method that gives any owner of any type of illiquid asset, access to temporary liquidity without incurring debt obligations or giving up immediate possession or ownership. Such liquidity could be provided in the form of a deposit from an asset buyer who undertakes the obligation and duty to purchase the asset at a fixed price, within a fixed period of time in the future, on demand of the asset owner, by the asset owner simply delivering possession of the asset to the asset buyer. This obligation of the asset buyer to complete the purchase at the fixed price anytime during the fixed period upon the demand of the asset owner, serves to fulfill the critical function of transferring the burden of risks of adverse changes in market conditions and/or asset values, off of the asset owner and onto the asset buyer. An additional provision enabling the asset owner to avoid the completion of the sale to the asset buyer would serve to allow the asset owner to retain long-term ownership of the asset beyond the contract period, at the asset owner's sole discretion. Further, such a financial tool should be much simpler, easier, and more readily practiced 2-party agreement in which the liquidity provided can be used for any purpose, by any asset owner, whether the asset owner is a consumer, commercial concern, or otherwise.

### SUMMARY OF THE INVENTION

General purposes of the invention include providing an owner of an illiquid asset a means for extracting temporary liquidity from that illiquid asset, without incurring any debt and without the loss of the possession and/or use of the asset, and providing a dealer-asset buyer the opportunity to pre-market potential new inventory so as to reduce the costs of maintaining actual physical inventory including storage, handling, display and other carrying costs, enabling the asset dealer to pass those savings along to the eventual end-user retail asset buyer.

This invention accomplishes those purposes by the means of: 1) an earnest money deposit provided by an asset buyer to an asset owner, under a contract for purchase of the asset with a provision for future completion of the transaction (to occur by means of delivery of possession and ownership of the asset to the asset buyer, and delivery of the remaining unpaid portion of the selling price to the asset owner) at any time on or before the last day of the agreed upon contract period, and 2) additional contract provisions which enable the asset owner to avoid the completion the sale of the asset to the asset buyer, including but not limited to a right to receive a waiver of the asset buyer's right to specific performance of completion of the sale under the contract; and/or a right for the asset owner to rescind the contract, with the granting of such rights further serving to enable the asset owner to retain permanent ownership of the asset, upon the exercise of such rights by means of the simple return of the earnest money deposit to the asset buyer, along with the specified valuable consideration to the asset buyer, if any, such as a fee for the waiver of specific performance, and/or liquidated damages to compensate for the various risks and detriments incurred by the asset buyer during the contract period, at any time on or before the last day of the contract period, and 3) the optional inclusion of a contract provision which would enable the asset owner to retain the possession, use and partial ownership of the asset without the necessity of refunding the earnest money deposit, or the payment of fees or liquidated damages, if any, to the asset buyer, in exchange for a percentage of ownership of the asset being attributed and/or transferred to the asset buyer on or before the last day of the contract period, along with a provision for an amount of rent to be paid to the asset buyer for the asset owner's continued sole possession and use of the then jointly owned asset.

While the prior art tool known as a purchase order may (but most often does not) involve a deposit from buyer to seller, its use it typically limited to business-to-business commercial transactions. Further, those commercial transactions typically involve goods which are either yet to be produced or are part of a larger inventory of fungible new goods (as opposed to used assets). Because the purchase order is a tool which is used to purchase goods from manufacturers or other commercial inventory sellers who are selling their inventory in the ordinary course of their business, purchase orders do not contemplate nor include rescission or other cancellation provisions for sellers.

The teaching of the prior art is limited to only two basic types of methods for extraction liquidity from an illiquid asset. The first type is the simple liquidation sale of the asset. The second type is the pledging of the asset as security for a loan, which creates new debt.

The limitations inherent in both types of existing financial transaction models become problematic in the many instances where a liquidation sale is not possible because the asset owner desires or requires continued possession and use of the asset, and a loan is not possible and/or advisable because the asset owner lacks the current means and/or risk tolerance for a new obligation to monthly debt service payments and the eventual duty to repay in full.

Oftentimes, the situation arises where an asset owner has an acute need for liquidity at the very same time as (and often caused by) being faced with the circumstances of reduced income, cash flow, and/or other diminishment of the capacity to service debt. Under these circumstances, the asset owner would be best served by accessing or extracting the needed liquidity from the asset without incurring additional debt obligations and without giving up the possession and use of the asset.

According to a preferred embodiment of the present invention, a system, and method which provides an asset owner with the time and wherewithal for a calm and reasoned assessment of future financial conditions to determine whether the optimum long-term decision would be to divest or retain the asset. And, if the final decision is divestment, it would allow the asset owner a reasonable period of time in which to attempt to maximize the sale price by finding another asset buyer, such as an end-user retail buyer who may be willing to buy the asset at price higher than a dealer-asset buyer using the present invention to acquire inventory at wholesale for re-sale.

Utilizing the teachings of the present invention would put an otherwise potentially necessitous asset owner-seller into an incredibly strong bargaining position as against third party end-user buyers, because the asset owner-seller could take great comfort in the knowledge that his “fall-back ” position of the otherwise acceptable sale price to the dealer-asset buyer, is already contractually assured. What the dealer-asset buyer may lose in asset purchases lost to higher bidding end-users ostensibly would be at least partially offset by the previously described clear and strong advantages provided by the “virtual inventory” period associated with those assets under contracts using the present invention which are not rescinded and the assets are actually delivered to the dealer-asset buyer on or before the last day of the pre-agreed contract period.

As has been shown, all of the prior art attempts to provide needed liquidity involve either the immediate liquidation sale of the asset, the creation of new debt obligations secured by the asset or narrow applications to only one certain type of asset. The only exception is one well-worn financing tool, which combines an immediate sale of an asset along with a means to regain possession and use of the asset. It is commonly known as a sale and leaseback. This tool is most commonly used by large and extremely creditworthy retail businesses that sell their real property to leasing companies and then pay rent to those leasing companies for the rights to continued possession and use of those real property assets. This prior art is significantly different from the present invention and fails to achieve the same useful ends, because it requires the sale of the asset by the asset owner at the very outset, along with the immediate commencement of the new obligation to make monthly lease payments (or if payments were deferred it would cause a significant reduction in the amount of asset sales proceeds liquidity provided).

The addition of a new monthly lease payment obligation presents virtually the same detriments as a new monthly debt payment obligation, which in many cases may be beyond the current risk tolerance, creditworthiness and/or financial capacity of the asset owner. Further, this prior art fails to provide any liquidity for any period of time prior to the completion of the asset sale. Therefore, it fails to provide an asset owner with any liquidity to allow the asset owner the opportunity to re-assess all other options from a position of somewhat increased financial strength.

As many asset owners are psychologically, or otherwise, very reluctant, at least initially, to sell assets, even in times of great need of financial liquidity, many asset owners may strongly desire some extra time to explore their options and think clearly from a position of greater financial strength prior to making a final decision to follow through on a sale of any asset. Using the prior art method of the sale and leaseback, once the property is sold to the leasing company, all of the upside potential in the value of the asset is immediately transferred from the asset owner to the leasing company. In deep contrast, by practicing the present invention the asset owner would maintain all of the upside potential in the value of the asset by means of the exercise of a right to waive the duty to deliver or a right of rescission which would enable the asset owner to capture any upward valuation that may materialize during the contract period.

Some sale and leaseback financiers have attempted to provide a means for giving the upside potential back to the asset seller, by granting the asset seller an option to repurchase the asset back from the leasing company. Unfortunately, when the attempt is made to apply that solution to riskier non-real property assets and/or to riskier non-creditworthy asset owners, it fails to truly shield the asset owner from virtually the same absolute duty to repay the leasing company as would normally be associated with a loan. That is because, in order to protect itself against the significantly increased risk of its failure to find and take possession of movable personal property assets in the event of the non-creditworthy former asset owner's failure to make the lease payments, the leasing company must prepare for anticipated future losses by paying the asset owner a purchase price which is significantly below the asset's true wholesale liquidation value. Even if the former asset owner is given an option to repurchase at a similarly artificially reduced price, in the event that the former asset owner is financially unable to provide the means to exercise the repurchase option prior to its expiration, then the former asset owner will have forever forfeited the right to receive any of the non-economic and contrived reduction in the selling price demanded by the leasing company. That big detriment is what leads to the situation where some sale-and-leaseback-with-repurchase-option transactions are construed by courts to be a loan which has merely been labeled with a different name. Because while a loan is defined by an absolute duty to repay, even though it may not be expressed in the sale and leaseback with option to repurchase contract, if the selling price therein is too significantly below wholesale liquidation value of the asset, then for all practical purposes the former asset owner has the “absolute duty” (at least to avoid forever losing a substantial portion of the value of the asset) to “repay” the leasing company (by repurchasing under the option to repurchase), which is at least as strong as it would be under a regular loan contract.

In bright contrast, while the preferred embodiment of the present invention does provide for protection of the asset buyer by enabling the asset buyer to negotiate an earnest money deposit amount which represents less than 100% of the agreed upon selling price, by using the present invention, the asset owner truly has absolutely no duty to repay, either contractually, practically or otherwise. This is so because the present invention requires that the asset buyer is contractually obligated to pay the asset owner, upon delivery of the asset to the asset buyer, the entire remaining balance of the agreed upon fair selling price minus only a true economic and reasonable charge for some of the risk and detriment incurred during the contract period. In contrast to the sale and leaseback with option to repurchase, when utilizing the present invention, there is no motivation or need for any artificially contrived non-economic reductions in the selling price to protect the asset buyer from future risks, because the present invention provides that at that point where the sale has been completed, there are no future risks between the parties, as all their dealings have then become final.

While the prior art of the sale and leaseback with option to repurchase is geared toward and often practiced by financiers attempting to create quasi-debt in the anticipation of being repaid their money with interest, by contrast, the present invention is geared toward and intended to be practiced by asset dealers attempting to develop a new source of inventory, priced at dealer wholesale fair value, which can be pre-marketed to increase inventory turnover and thereby reduce operating expenses, all while providing an additional new and useful service to asset owners in the process.

To summarize, the present invention represents a long-needed, new, useful, significant and positive step forward in the art of extracting liquidity from illiquid assets, which both improves upon and differs significantly from the mostly well-worn prior art, in that it involves: no debt, no debt service payments, no absolute duty to repay, no risk of deficiency judgment, no risk of excessive or unexpected decline in market value of the asset during the contract period, and no interest charges are billed or accrued on the earnest money deposit provided to the asset owner.

The old tried and true real estate earnest money deposit concept forms the backbone of the present invention. Prior to the increasingly common use of the “escrow closing”, if a debt-free real estate seller received a no-contingency all cash offer accompanied by an earnest money deposit from the buyer to bind the seller to the deal, upon the seller's acceptance of the offer, the seller would be free to use this new earnest money liquidity infusion for any purpose from the very first day it was received, despite the fact that the sale would not be finalized until all the papers had been drawn. This is so because the seller already knows if seller is ready, willing and able to deliver title to the buyer at closing, and therefore, that the earnest money would remain the property of seller, with no duty to ever repay.

Similarly, the first step in the method of practicing this invention begins with an asset buyer who offers to buy an asset from an asset owner within a specified period of time after the acceptance of the offer, including a substantial earnest money deposit to be paid from asset buyer to asset seller upon asset seller's acceptance of the offer as a binding contract. However, even though the asset owner may want to use the buyer's earnest money deposit, the asset owner may have not yet arrived at a final decision to sell the asset.

Therefore, the second and key inventive step involved in practicing this new method, is the inclusion of a clause in the asset purchase offer which provides the asset owner (who heretofore was traditionally bound by the earnest money deposit to specifically perform the contract by completing the sale), with the right to gain the asset buyer's waiver of any rights to enforce the specific performance of the completion of the sale under the contract and/or grants the asset owner the right to rescind the contract, upon election by the asset seller at any time on or before the last day of the contract period, by simply returning the earnest money deposit received, along with the specified amount of the fee for such waiver or rescission, if any, and/or the liquidated damages, if any, calculated to reasonably compensate the asset buyer for some of the risks and detriments incurred by entering into the purchase contract with the asset owner (hereinafter referred to as “Waiver” or “Waived”).

The third step involves specifying the amount of the liquidated damages, if any, by estimating the anticipated average actual damages and then specifying that amount in the contract along with the decision as to whether or not that amount is to be prorated in the event of early Waiver prior to the last day of the contract period.

Step four is to decide whether or not to incorporate any deductions from the gross purchase price of the asset as a fee to defray any portion of the many risks and detriments actually and/or potentially incurred by the asset buyer during the contract period, including but not limited to: depreciation, uninsured physical damage, market place shifts and/or disruptions leading to sudden and/or significant adverse changes in asset values, loss on contracts not rescinded with assets never delivered or recovered, expense of attempts to locate and/or recover undelivered assets, expense of actual recovery and delivery of assets, loss of re-sales anticipated to consummate upon delivery of the asset on or before the last day of the contract period (in the absence of rescission), loss of reputation with re-sale buyers due to failure to receive inventory on or before the last day of the contract period as anticipated (in the absence of rescission), and the risk of new liens attaching in a position senior to the rights of the asset buyer by either possession, operation of law or otherwise. (This list would also be relevant to the estimation of actual damages and the determination of the liquidated damages amount, if any, in the third step described above.) Any such deduction(s) agreed upon by the parties would be specified in the contract. Also to be decided in this step would be whether or not to prorate any such fee or portion thereof in the event of early delivery of the asset to the asset buyer prior to the last day of the contract period.

The fifth step is to decide whether or not to take and/or record a lien on the asset as security for the asset owner's promise to either rescind the contract or deliver the asset to the asset buyer on or before the last day of the contract period. This decision may vary in each case according to the jurisdiction, type of asset, owner and reputation. In the event that the decision is agreed upon to include a security interest and/or the perfection/recordation thereof, such agreement shall be specified in the contractual documents.

The sixth step is to decide if any pre-agreed contract-renewal options will be included, and if so, the terms and conditions thereof would also be specified in the contract.

The seventh step is to decide whether to include a provision in the contract which would enable the asset owner to retain the possession, use and partial ownership of the asset without the necessity of refunding the earnest money deposit, or the payment of fees or liquidated damages, if any, to the asset buyer, in exchange for a percentage of ownership of the asset being attributed and/or transferred to the asset buyer on or before the last day of the contract period, along with a provision for the amounts and timing of the rent to be paid to the asset buyer for the asset owner's continued possession and use of the then jointly owned asset.

The eighth step is to decide whether it may be necessary or desirable to include any additional agreements to induce the asset buyer to enter into the asset purchase contract, either as part of the asset purchase contract or by separate agreement(s), included here by way of example but not limitation: consignments, brokerage listings and/or revenue sharing agreements.

In conclusion, this invention provides a long needed, new and more useful, more flexible and desirable, kinder and gentler means of providing temporary liquidity to those asset owners who could benefit by having some additional financial strength along with some more time to assess and determine their best option for the disposition of an asset, within a reasonable period of time.

### DESCRIPTION OF THE INVENTION

Possible embodiments will now be described with reference to the drawings and those skilled in the art will understand that alternative configurations and combinations of components may be substituted without subtracting from the invention. Also, in some figures certain components are omitted to more clearly illustrate the invention.

In a first preferred embodiment, the present invention comprises a method for extracting liquidity (liquid assets) from an illiquid asset using a contractual instrument. The preferred method enables an asset owner to retain title, ownership, possession, control, and full use of the asset during the contractual period. The buyer provides liquidity to the asset owner in return for a future promise from the asset owner to sell the illiquid asset. The liquidity provided by the buyer is an earnest money deposit, which represents a portion of an agreed value of the illiquid asset, in the form of cash or other negotiable instruments, given in anticipation of the future acquisition of the asset owner's illiquid asset.

The illiquid asset typically consists of personal property or real property owned in fee-simple by the asset owner. Examples of such property include, without limitation, motor vehicles, equipment, jewelry, buildings or land.

One step of this first preferred method requires a purchase commitment for the illiquid asset. The illiquid asset owner and the buyer determine and agree upon a purchase price for the asset at any reasonable amount, such as the current wholesale market fair value. Generally included within the process of determining a purchase price for an illiquid asset, is the accessing and assessment of one or more of a wide variety of types of data, many of which relate to the determination of a valuation upon which to base a purchase price. Such valuations are typically various types of estimates or appraisals made with the aid of and/or based upon knowledge of comparable sales and/or inventory data, directly from the appraiser's personal, professional and/or organizational experience or observations in the marketplace, auctions sales and inventory data, published guides such as Kelly Blue Book, Black Book, and NADA, various market supply and demand factors, inspections and tests to determine the physical condition of the asset, replacement cost and/or rental rates, and/or any and all other such data as may be used as an aid in determining any type of valuation or purchase price. Any alternative valuation methods can be used. For example, an estimated future value, or any other price negotiated between the buyer and seller. A purchase price may be determined through negotiations conducted relative to and/or with the aid of any such valuations. A purchase price is included in the asset buyer's commitment to purchase the illiquid asset from the asset owner.

Another step according to this first preferred method includes a payment of an earnest money deposit from the buyer to the illiquid asset owner. This earnest money deposit reflects an amount less than the valuation of the illiquid asset and is provided to the seller as evidence that the promise of a future purchase of the illiquid asset by the buyer is being made in earnest.

Another step according to this first preferred method includes allowances or deductions from the valuation of the illiquid asset. These allowances or deductions may take the form of fees, expenses, or costs and may be deducted first from the valuation amount agreed upon between buyer and owner. Such deductions reflect the anticipation of the costs and risks of the future transaction. One contemplated risk includes the possibility that the asset owner will not deliver possession of the illiquid asset to the buyer at the end of the contractual period. Another contemplated deduction includes an assessment of the anticipated decline in value of the asset in the future due to its use during the contractual period. Yet another contemplated deduction includes an unanticipated loss of value of the asset due to unforeseen market fluctuations between the date the agreement is first entered into and the actual future delivery date of the asset.

Yet another step according to this first preferred method of the present invention includes a determination and agreement between asset owner and buyer of the contract duration—that is the date the illiquid asset will be turned over to the buyer. An additional step of the present method includes a provision for an early delivery or transfer of the illiquid asset from the owner to the buyer at any time on or before the last day of the contract whereupon the remaining balance of the agreed upon purchase price (minus any agreed upon deductions), is paid to the asset owner.

A key step of this first preferred embodiment includes the ability of the illiquid asset owner to receive a waiver of the asset buyer's right to specific performance of the sale of the asset—that is, the asset owner may elect to not deliver the illiquid asset—by paying a waiver fee. This waiver fee (a monetary amount agreed between the illiquid asset owner and the asset buyer), together with the return of the earnest money deposit, may be paid to the asset buyer at any time during the contract period and this payment would effectively rescind the contract or otherwise excuse the asset owner from specifically performing the delivery and transfer of title of the illiquid asset to the asset buyer.

Another contemplated step of this preferred embodiment includes a liquidated damages amount to compensate the buyer's exposure to risk prior to any breach or rescission by the asset owner. This liquidated damages amount includes compensation for the loss from failure to acquire the asset and having to remove the potential asset from a virtual inventory of (future) assets available for sale by the buyer. For example, a car dealer may rely on the delivery of a particular motor vehicle (the illiquid asset) at a future date and place into a virtual inventory (for example, an on-line advertisement with date available of a particular motor vehicle). The loss of this sale opportunity and any associated good-will is captured in the liquidated damages amount.

Another step of this preferred method includes, providing the buyer a security interest in the asset to secure asset owners duty to deliver possession (or a damages amount in the event of breach and/or rescission). At the buyer's option, this security interest may be recorded as a lien on the asset.

Additionally, another contemplated step of the present invention includes enabling the asset owner and buyer to pre-determine one or more renewal options.

This first preferred method adapts readily to a contractual instrument entered into between the illiquid asset owner and the asset buyer.

By way of example, this first preferred method provides cash today (liquid asset) to the owner of a motor vehicle (illiquid asset). For example, an automobile dealer that resells its inventory at wholesale, extends a standing offer to the car owning public, to pay them 90% of wholesale value for their cars, in the form of cash-on-the-spot for those who have made the final decision to sell. However, not every asset owner is ready today to sell their car (motor vehicle, illiquid asset). The present invention provides a means for the undecided asset owner to obtain both immediate cash and additional time to make a final decision. The method of this invention provides such car (illiquid asset) owners with some ready cash to put them into a position of greater financial strength and thereby afford them the time and wherewithal to make their ultimate best decision.

Accordingly, the car dealer offers to enter into a contract with the car owner for the car, which in this example is the car owner's 2003 Honda Civic with 80,000 miles, and the contract will provide for all of the following:

1. A purchase price equal to 90% of the wholesale fair value of the car as determined through the use of a machine to access the internet to gather valuation data from such sources as kbb.com and Edmunds.com, which as of this writing would be a wholesale fair value of the car of approximately $5,000, of which 90% equals the agreed wholesale fair purchase price of $4,500;

2. Immediate delivery from the dealer to the car owner, an earnest money deposit equal to 50% of the agreed wholesale fair purchase price of the car, which would be $2,250;

3. A contract period of an agreed number of months from the date of the contract inception;

4. The dealer's irrevocable promise to deliver the remaining 50% of the agreed wholesale fair purchase price of the car which would be $2,250, minus a risk fee in the amount of 10% of the wholesale fair value of the vehicle, which would be $500, deducted to compensate for the dealer's exposure to the various risks and detriments during the contract period (including depreciation, damage and/or the car owner's failure to either deliver possession of the car to complete the sale, or return the earnest money upon election of waiver of specific performance or rescission, on or before the last day of the contract period), leaving a final cash payment to the car owner in the amount of $1,750 as the final remaining balance of the purchase price.

5. The car owner is granted the right to receive a waiver of the car dealer's right to the specific performance of the car owner's completion of the sale and delivery of the car to the dealer, and/or the right to rescind the contract, without cause, and thereby prevent the anticipated sale and retain permanent ownership of the car by simply returning the earnest money plus liquidated damages equal to the risk fee of 10% of the wholesale fair value of the car as described in #4 above.

6. During the entire contract period the car owner remains free to use the earnest money deposit received for any purpose, free to keep and drive the car, free to seek out a retail buyer willing to pay a higher price for the car than the car dealer has agreed to pay, and of course, free to attempt to improve the financial situation, replenish liquidity from other sources and elect to keep the ownership of the car on a permanent basis by simply returning the earnest money deposit plus liquidated damages equal to the risk fee of 10% of the wholesale fair value of the car as described in #4 above.

7. Also during the entire contract period, the car dealer is free to pre-market the asset as being anticipated new inventory (subject to the car owners right of rescission), by advertising, posting and/or listing the details of the car and the date of the last day of the contract period, for the purpose of developing a list of interested potential buyers to contact if and when the dealer receives possession of the inventory and/or for pre-arranging the resale of the car contingent upon the car actually being delivered to the car dealer on or before the last day of the contract period (where allowed by law), and passing the cost savings garnered by the resulting faster inventory turnover, on to the car buying public. (This contract described above is referred to hereafter as the “Dealer Guaranteed Purchase Contract”.)

Another preferred embodiment utilizes the Dealer Guaranteed Purchase Contract in conjunction with a consignment contract (“Consignment”). This embodiment includes a method that eliminates fees or damage amounts associated with the asset owner's failure to deliver possession and complete the sale of the asset under the Dealer Guaranteed Purchase Contract. In this preferred embodiment the asset owner enters into a Consignment with the asset dealer as an inducement for the asset dealer to enter into a Dealer Guaranteed Purchase Contract and/or for the purpose of seeking a retail buyer for the asset seller's asset. By utilizing this embodiment, and given a sufficiently long period of Consignment, which may or may not be a period of time which is much longer than the period of the Dealer Guaranteed Purchase Contract, the asset dealer may be willing to forego compensation for the risks undertaken (or any part thereof) under the Dealer Guaranteed Purchase Contract, instead relying solely on the hope of eventually receiving compensation from performance of the provisions of the Consignment, upon the sale or transfer of the asset.

Similarly, in another preferred embodiment, which is intended to address those situations where certain assets are typically sold by asset brokers through brokering arrangements, the Dealer Guaranteed Purchase Contract is utilized in conjunction with a brokerage and/or listing agreement (“Listing”), and is then applied in a similar fashion as described in the previous embodiment related to consignment above.

Another embodiment may be preferred in the event that the subject asset is one which is currently (and/or intended to be) employed producing revenues, including by way of example, but not limited to: income producing real property, contract rights and intellectual property rights. In such circumstances the asset owner may offer the asset dealer some portion of the revenue produced by the asset, as an inducement for the asset dealer to enter into a Dealer Guaranteed Purchase Contract. This embodiment may be utilized separately or in combination with any element(s) of the other preferred embodiments such as a Consignment or a Listing, and with or without any compensation to the asset dealer in the event that the asset seller fails to deliver the asset to the asset dealer under the terms of the Dealer Guaranteed Purchase Contract.

Yet another preferred embodiment is intended to address those certain situations where, in anticipation of the last day of the contract period, the asset owner realizes a desire to continue to retain possession and use of the asset after the last day of the contract period, but also anticipates a lack of the funds necessary to refund the earnest money deposit received, along with the agreed upon fees and/or damages, if any, to the asset buyer on or before the last day of the contract period. To anticipate and accommodate the needs of the asset owner in such situations, a provisions are included in the contract which serve to enable the asset owner to retain the possession, use and partial ownership of the asset without the necessity of refunding the earnest money deposit, or the payment of fees or liquidated damages, if any, to the asset buyer, in exchange for a percentage of ownership of the asset being attributed and/or transferred to the asset buyer on or before the last day of the contract period, along with a provision for the amounts and timing of the rent to be paid to the asset buyer for the asset owner's continued possession and use of the then jointly owned asset.

In other preferred embodiments, the present invention consists of a system including a method and an apparatus for representing a physical object into a first data set and then transforming the first data set into a second data set. Accordingly, the apparatus of the system, in one preferred embodiment the apparatus comprises a general purpose computer having an input means, a display (or output) means, a storage means, and a processing means. A software program coded with machine executable instructions according to any one of the above methods of the present invention resides in a memory means on the general purpose computer, thus rendering the apparatus as a specific purpose computer. The first data set consists of variables representing a physical object. The physical object comprises an illiquid asset in the form of personal property or real property, for example, a watch, an automobile, a house, etc. Variables representing the tangible object vary depending on the nature of the illiquid asset (tangible object). For example, an automobile is represented by a first data set comprising the year, make, model, engine displacement, transmission type, weight, dimensions, fuel economy rating, crash-test results, quality of the paint, quality of the interior, exterior color, interior color, interior fabric, Kelly Blue Book value, and numerous other data variables that would quantify and qualify the tangible object expressed as a data set. In a preferred embodiment this first data set is preferably the present value of the vehicle as assessed by various valuation means well-understood in the art. Next the system of the present invention in a preferred embodiment utilizes this first data set representing the illiquid asset and transforms it into a second data set representing the contract duration and earnest money deposit to the asset owner (along with other variables previously discussed herein in relationship to the various methods of the present invention). This second data set, in a preferred embodiment, is displayed on an output means of the computer apparatus.

One possible apparatus of the present invention includes an Apple Macintosh “Mac mini” microcomputer with a Power PC G4 1.25 GHz processor with an internal memory cache of 512 KB and 1 GB of memory and an 80 GB internal had drive for read/write storage ability running the MAC OS operating system and having a C++ encoded software program of the methods according to the present invention. Coupled to this processor, a wireless mouse and wireless keyboard operate as input devices and output means comprise a 17″ flat-panel LCD monitor and a laser-jet printer.

Although the invention has been particularly shown and described with reference to certain embodiments, it will be understood by those skilled in the art that various changes in form and detail may be made without departing from the spirit and scope of the invention.

I claim:

1. A method for liquefying and extracting liquidity from an illiquid asset for an asset owner by an asset buyer, the method comprising:
determining a purchase price for the illiquid asset;
determining and paying an earnest money deposit to the owner;
making an irrevocable promise for the future purchase of the illiquid asset by the buyer;
determining any deductions from the purchase price;
determining a contract duration including a future date for delivery of possession of the asset from the owner to the buyer; and
receiving from the buyer a right that would enable the owner to negate the owner's duty to deliver possession of the illiquid asset to the buyer on or before the end of the contract duration.

2. The method of claim 1 further comprising:
determining a valuation of the illiquid asset; and
estimating a future value of the illiquid asset, and at least one of the following steps comprising
determining a current wholesale fair market value, or
negotiating a valuation amount agreeable between buyer and owner, determining a purchase price, or
negotiating a purchase price amount agreeable between buyer and owner.

3. The method of claim 1 further comprising at least one of the following:
determining a contract duration including a future delivery date of possession of the asset from the owner to the buyer, or
negotiating a contract duration including a future delivery date of possession of the asset from the owner to the buyer agreeable between buyer and owner.

4. The method of claim 1 wherein determining the earnest money deposit comprises:
negotiating an amount less than the valuation
calculating an amount less than the valuation.

5. The method of claim 1 wherein determining any deductions from the purchase price comprises at least one of the following:
determining that there are no deductions;
determining a first deduction based on an anticipated cost and risk of a the owner not delivering the illiquid asset to the buyer on or before the contract duration;
estimating an anticipated decline in value of the illiquid asset in the future due to its use during the contract duration;
estimating the potential for an unanticipated loss of value of the illiquid asset due to unforeseen market fluctuations; or
determining an amount for a provision for an early delivery or transfer of the illiquid asset before an end of the contract duration.

6. The method of claim 1 further comprising:
determining a liquidated damages amount to compensate the buyer for exposure to risk prior to delivery of the illiquid asset.

7. The method of claim 1 further comprising:
providing the buyer a security interest in the illiquid asset to secure the owner's duty to deliver possession of the illiquid asset.

8. The method of claim 1 further comprising:
providing a renewal option.

9. The method of claim 1 further comprising:
creating a contractual instrument between the buyer and the owner.

10. The method of claim 1 further comprising:
providing a consignment contract between the buyer and the owner.

11. The method of claim 1 further comprising:
providing a brokerage or listing contract between buyer and owner.

12. The method of claim 9 further comprising:
providing a dealer guaranteed purchase contract between buyer and owner.

13. The method of claim 1 further comprising:
providing an income-producing or revenue generating illiquid asset; and
determining a portion of the revenue or income of the illiquid asset to be paid to the buyer.

14. The method of claim 1 further comprising:
enabling the owner to maintain use of the illiquid asset after the contract duration; and
providing partial ownership to the buyer after the contract duration.

15. The method of claim 1 further comprising:
Providing a royalty contract.

16. The method of claim 1 further comprising:
enabling the buyer to promote the illiquid asset as potential future inventory for resale.

17. The method of claim 1 6 further comprising:
publishing, promoting and/or otherwise pre-marketing the potential future inventory for the purpose of generating indications of interest from prospective buyers and/or for generating purchase commitments from buyers contingent upon the potential future inventory becoming actual inventory.

18. A system for extracting value from an illiquid asset for an owner by a buyer, the system comprising:
a computer processor means for processing data;
an inputting means for entering data, the inputting means being in communication with the processor;
a storage means for storing data on a storage medium in communication with the processor;
a first means for initializing the storage medium;
a second means for processing data regarding the value of the illiquid asset;
a third means for processing data regarding an extracted liquidity of the asset wherein the extracted liquidity is a portion of the value of the asset and is provided to the asset owner from an asset buyer as an earnest money purchase deposit and wherein the valuation is calculated using factors representing a future purchase value of the illiquid asset; a deduction amount; a contract duration; and a liquidated damages amount to compensate the buyer for exposure to risk prior to delivery of the illiquid asset.

19. The system of claim 17 further comprising:
a computer-executable program residing in a memory means coupled to the processor, the computer executable program comprising instructions including,
determining a valuation of the illiquid asset with the aid of an internet access machine;
determining a purchase price for the illiquid asset with the aid of the valuation;
determining and paying an earnest money deposit to the owner;
promising an irrevocable future purchase of the illiquid asset by the buyer;
determining any deductions from the purchase price;
determining a contract duration including a future date for delivery of possession of the asset from the owner to the buyer; and
receiving from the buyer a right that would enable the owner to negate the owner's duty to deliver possession of the illiquid asset to the buyer on or before the end of the contract duration.
